(19) United States
(12) Patent Application Publication
(10) Pub. No.: US 2016/0109765 A1
(43) Pub. Date: Apr. 21, 2016

(54) CURVED DISPLAY DEVICE

(71) Applicant: Samsung Display Co., Ltd., Yongin-City (KR)

(72) Inventors: Sang-Myoung LEE, Seoul (KR); Hyun-Ho KANG, Ansan-si (KR); O Sung SEO, Seoul (KR); Young Goo SONG, Asan-si (KR); Seung Jun YU, Suwon-si (KR); Ha Won YU, Suwon-si (KR); Ki Kyung YOUK, Bucheon-si (KR); Tae Kyung YIM, Seoul (KR)

(21) Appl. No.: 14/710,213

(22) Filed: May 12, 2015

(30) Foreign Application Priority Data
Oct. 16, 2014 (KR) 10-2014-0139794

(51) Int. Cl. G02F 1/1343; G02F 1/1333; G02F 1/1335; G02F 1/1368; G02F 1/1362

(52) U.S. Cl. CPC G02F 1/134309; G02F 1/1368; G02F 1/136286; G02F 1/133514; G02F 1/133345; G02F 2001/134345

(57) ABSTRACT

A curved display device according to an exemplary embodiment of the present system and method includes: a first insulation substrate; a gate line and a data line disposed on the first insulation substrate to cross each other; a thin film transistor coupled to the gate line and the data line; a pixel electrode disposed on the thin film transistor; a common electrode facing the pixel electrode; and a liquid crystal layer disposed between the pixel electrode and the common electrode and having liquid crystal molecules. The pixel electrode includes: a cross-shaped stem portion; minute branch portions extending from the cross-shaped stem portion; and minute slits disposed between the minute branch portions, wherein a width of the minute slit is greater than that of the minute branch portion.

### CROSS-REFERENCE TO RELATED APPLICATION

This application claims priority to and the benefit of Korean Patent Application No. 10-2014-0139794 filed in the Korean Intellectual Property Office on Oct. 16, 2014, the entire contents of which are incorporated herein by reference.

### BACKGROUND

(a) Field

The present disclosure relates to a curved display device.

(b) Description of the Related Art

A liquid crystal display (LCD) includes two display panels on which field generating electrodes such as a pixel electrode and a common electrode are formed, and a liquid crystal layer interposed between the two display panels. The LCD displays an image by applying a voltage to the field generating electrodes to generate an electric field in the liquid crystal layer. The strength of the generated electric field determines the alignment directions of the liquid crystal molecules, and thereby, the polarization of incident light of the liquid crystal layer. Thus, the LCD displays an image by controlling the polarization of incident light of the liquid crystal layer.

In the LCD, an alignment layer may be used to align the liquid crystal molecules of the liquid crystal layer in a desired direction. In addition, when the electric field is applied to the liquid crystal layer, the liquid crystal molecules are arranged such that they are pre-tilted in predetermined directions. The liquid crystal molecules may be pre-tilted using a method in which a reactive mesogen is mixed in the liquid crystal layer and subsequently photopolymerized.

As LCDs increase in size, curved display panels have been developed to enhance immersion and realism of viewers. However, when the display panels are curved, misalignment of upper and lower substrates may occur, thereby resulting in a decrease in luminance.

### SUMMARY

The present system and method provide a curved display device that has improved liquid crystal control in its lower panel.

The present system and method also prevent or mitigate decreases in luminance due to misalignment of the upper and lower substrates through liquid crystal control of the lower panel.

An exemplary embodiment of the present system and method provides a curved display device including: a first insulation substrate; a gate line and a data line disposed on the first insulation substrate to cross each other; a thin film transistor coupled to the gate line and the data line; a pixel electrode disposed on the thin film transistor; a common electrode facing the pixel electrode; and a liquid crystal layer disposed between the pixel electrode and the common electrode and having liquid crystal molecules. The pixel electrode includes: a cross-shaped stem portion; minute branch portions extending from the cross-shaped stem portion; and minute slits disposed between the minute branch portions, wherein a width of the minute slit is greater than that of the minute branch portion.

A ratio of the width of the minute slit to a width of the minute branch portion may be at least about 1.3.

A sum of the width of the minute branch portion and the width of the minute slit may be about 5 μm to 7 μm.

A sum of the width of the minute branch portion and the width of the minute slit may be about 7 μm.

The width of the minute slit may be more than about 4 μm.

A sum of the width of the minute branch portion and the width of one minute slit may be about 6 μm.

The width of the minute slit may be more than about 3.5 μm.

A sum of the width of the minute branch portion and the width of the minute slit may be about 5 μm.

The width of the minute slit may be more than about 3 μm.

The pixel electrode may include a first subpixel electrode and a second subpixel electrode, and the first and second subpixel electrodes may be spaced apart from each other based on the gate line.

The first and second subpixel electrodes may each include a plurality of cross-shaped stem portions.

The curved display device may further include: a gate insulating layer disposed on the gate line; a semiconductor layer disposed on the gate insulating layer; a first passivation layer disposed on the data line; a color filter disposed on the first passivation layer; and a second passivation layer disposed on the color filter and the first passivation layer.

The color filter may be one of a red color filter (R), a green color filter (G), and a blue color filter (B), and widths of the minute branch portions may be different depending on the color of the color filter.

The widths of the minute branch portions corresponding to the red color filter, the blue color filter, and the green color filter may be sequentially decreased in order.

The curved display device may exclude a reactive mesogen (RM).

According to the curved display device described above, liquid crystal control of the lower panel can be enhanced. Furthermore, texture caused by the misalignment of the upper and lower substrates can be controlled, thereby providing improved luminance.

### BRIEF DESCRIPTION OF THE DRAWINGS

FIG. 1 is a circuit diagram of one pixel according to an exemplary embodiment of the present system and method.

FIG. 2 is a top plan view of one pixel according to an exemplary embodiment of the present system and method.

FIG. 3 is a cross-sectional view of FIG. 2 taken along the line III-III.

FIG. 4 is a top plan view of a basic electrode according to an exemplary embodiment of the present system and method.

FIG. 5 is a top plan view of one pixel according to another exemplary embodiment of the present system and method.

FIG. 6 is a top plan view of basic electrodes corresponding to each color filter according to another exemplary embodiment of the present system and method.

FIG. 7A illustrates an image of an exemplary embodiment of the present system and method, and FIG. 7B illustrates an image of a comparative example.

FIGS. 8A and 8B illustrate images of an exemplary embodiment of the present system and method.

FIGS. 9A, 9B, 10A, 10B, 10C, 11A, 11B, 12A, 12B, 13A, 13B, 14A, 14B, 15A, 15B, 16A, 16B, 17A, and 17B are images of exemplary embodiments of the present system and method and comparative examples.

### DETAILED DESCRIPTION OF THE EMBODIMENTS

The present system and method are described hereinafter with reference to the accompanying drawings in which exemplary embodiments of the present system and method are shown.

Those of ordinary skill in the art would realize that the described embodiments may be modified in various different ways without departing from the spirit or scope of the present system and method.

In the drawings, the thickness of layers, films, panels, regions, etc. are exaggerated for clarity. Like reference numerals designate like elements throughout the specification. When an element such as a layer, film, region, or substrate is referred to as being “on” another element, it may be directly on the other element or intervening elements may be present. In contrast, when an element is referred to as being “directly on” another element, there are no intervening elements present.

A curved LCD display device according to an exemplary embodiment of the present system and method is described below with reference to the drawings.

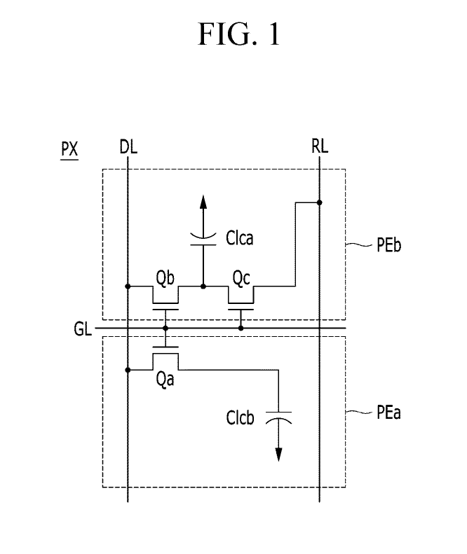

FIG. 1 is a circuit diagram of one pixel of the curved display device according to an exemplary embodiment of the present system and method. Referring to FIG. 1, the pixel PX includes: a plurality of signal lines including a gate line GL for transmitting a gate signal, a data line DL for transmitting a data signal, and a divided reference voltage line RL for transmitting a divided reference voltage; first, second, and third switching elements Qa, Qb, and Qc coupled to the signal lines; and first and second liquid crystal capacitors Clca and Clcb.

The first and second switching elements Qa and Qb are respectively coupled to the gate line GL and the data line DL. The third switching element Qc is coupled to an output terminal of the second switching element Qb and the divided reference voltage line RL.

The first and second switching elements Qa and Qb are three-terminal elements, such as thin film transistors and the like, and have their control terminals coupled to the gate line GL, and their input terminals coupled to the data line DL. The output terminal of the first switching element Qa is coupled to the first liquid crystal capacitor Clca. The output terminal of the second switching element Qb is coupled to the second liquid crystal capacitor Clcb and the input terminal of the third switching element Qc.

The third switching element Qc is also a three-terminal element, such as a thin film transistor and the like, and has its control terminal coupled to the gate line GL, its input terminal coupled to the second liquid crystal capacitor Clcb, and its output coupled to the divided reference voltage line RL.

When a gate-on signal is applied to the gate line GL, the first, second, and third switching elements Qa, Qb and Qc are turned on, and a data voltage from the data line DL is applied to a first subpixel electrode PEa and a second subpixel electrode PEb through the turned-on first and second switching elements Qa and Qb.

The first and second subpixel electrode PEa and PEb are applied with the same voltage from the data line DL. The first and second liquid crystal capacitors Clca and Clcb are charged with charges corresponding to a difference between a common voltage and the subpixel electrode voltage. However, because the voltage applied to the second subpixel electrode PEb is divided by the turned-on third switching element Qc, the charge in the second liquid crystal capacitor Clcb is decreased according to a difference between the common voltage and the divided reference voltage.

Since the voltages of the first and second liquid crystal capacitors Clca and Clcb are different from each other, the tilt angles of liquid crystal molecules of the first and second subpixels are different. As a result, the two subpixel electrodes have different luminances.

Accordingly, when the voltages of the first and second liquid crystal capacitors Clca and Clcb are appropriately adjusted, the side visibility of an image may be improved such that the side visibility closely approximates the front visibility of the image.

In the illustrated exemplary embodiment, the third switching element Qc coupled to the second liquid crystal capacitor Clcb and the divided reference voltage line RL is included to make the voltages charged to the first and second liquid crystal capacitors Clca and Clcb different, but different configurations may be possible in other embodiments.

For example, the second liquid crystal capacitor Clcb may be coupled to a step-down capacitor. Specifically, the third switching element may include a first terminal coupled to a step-down gate line, a second terminal coupled to the second liquid crystal capacitor Clcb, and a third terminal coupled to the step-down capacitor. In such case, because the charges in the second liquid crystal capacitor Clcb are partially charged in the step-down capacitor, the first and second liquid crystal capacitors Clca and Clcb have different charged voltages.

In another embodiment, the first and second liquid crystal capacitors Clca and Clcb may be coupled to different data lines such that they are applied with different data voltages. In such case, the first and second liquid crystal capacitors Clca and Clcb also have different charged voltages.

In the present specification, the circuit diagram of FIG. 1 is described, but it is not limited thereto. A structure of the pixel electrode of the present system and method may be applied to various structures.

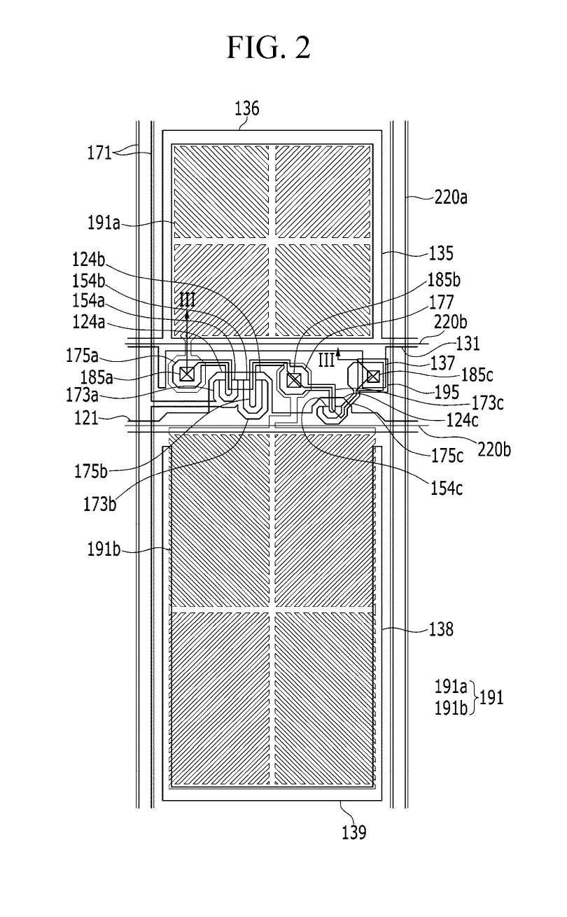

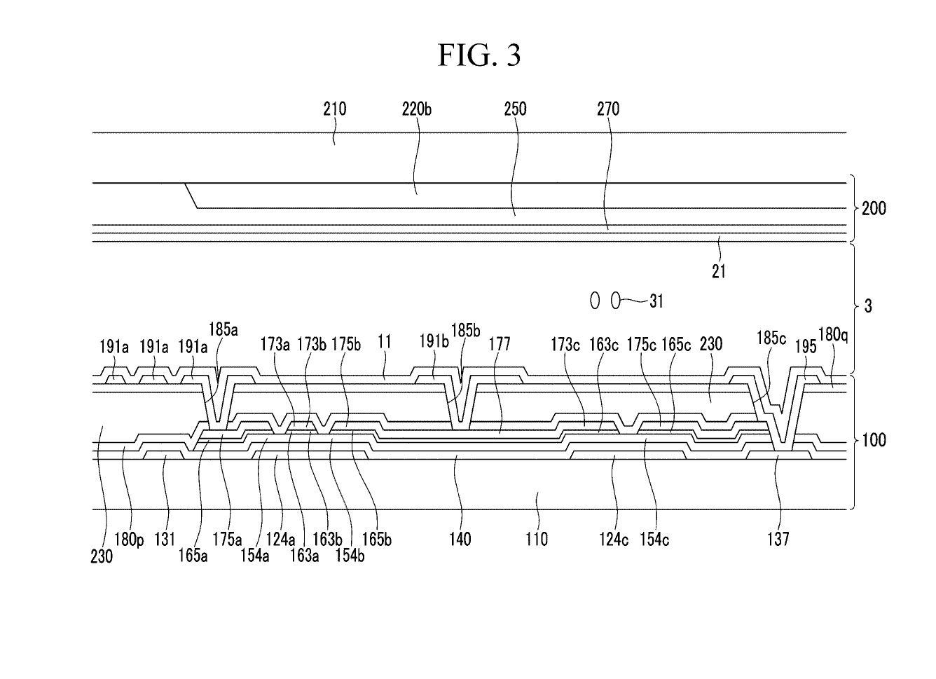

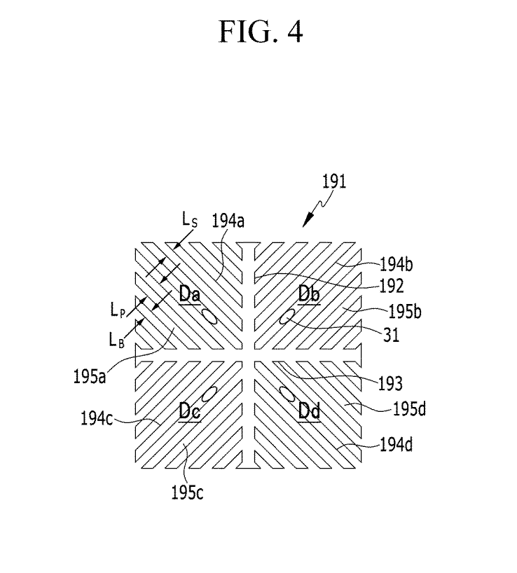

A structure of the LCD illustrated in FIG. 1 is described below with reference to FIGS. 2 to 4. FIG. 2 is a top plan view of one pixel of an LCD according to an exemplary embodiment of the present system and method. FIG. 3 is a cross-sectional view of FIG. 2 taken along the line III-III. FIG. 4 is a top plan view of an electrode according to an exemplary embodiment of the present system and method.

Referring to FIGS. 2 and 3, the LCD includes: a lower panel 100 and an upper panel 200 facing each other; a liquid crystal layer 3 including liquid crystal molecules 31 interposed between the upper and lower panels 100 and 200; and a pair of polarizers (not shown) respectively attached to outer surfaces of the upper and lower panels 100 and 200.

The lower panel 100 is described first. A gate conductor including a gate line 121 and a divided reference voltage line 131 is disposed on a first insulation substrate 110. The gate line 121 includes a first gate electrode 124a, a second gate electrode 124b, a third gate electrode 124c, and a wide end portion (not shown) for connecting with another layer or an external driving circuit.

The divided reference voltage line 131 includes first storage electrodes 135 and 136, and a reference electrode 137. Though not coupled to the divided reference voltage line 131, second storage electrodes 138 and 139 are also disposed to overlap the second subpixel electrode 191b.

A gate insulating layer 140 is disposed on the gate line 121 and the divided reference voltage line 131. A first semiconductor layer 154a, a second semiconductor layer 154b, and a third semiconductor layer 154c are disposed on the gate insulating layer 140.

A plurality of ohmic contacts 163a, 165a, 163b, 165b, 163c, and 165c are disposed on the semiconductor layers 154a, 154b, and 154c. A plurality of data lines 171 including first and second source electrodes 173a and 173b and a data conductor including a first drain electrode 175a, a second drain electrode 175b, a third source electrode 173c, and a third drain electrode 175c are disposed on the ohmic contacts 163a, 165a, 163b, 165b, 163c, and 165c and the gate insulating layer 140. The data conductor, and the semiconductor and the ohmic contacts disposed thereunder, may be formed simultaneously using one mask.

The data line 171 may include a wide end portion (not shown) for connecting with another layer or an external driving circuit, and may include the semiconductor layers 154a, 154b, and 154c and the ohmic contacts 163a, 165a, 163b, 165b, 163c, and 165c.

The first gate electrode 124a, the first source electrode 173a, and the first drain electrode 175a form a first thin film transistor Qa along with the first semiconductor layer 154a. A channel of the first thin film transistor Qa is formed at the first semiconductor layer 154a between the first source electrode 173a and the first drain electrode 175a.

The second gate electrode 124b, the second source electrode 173b, and the second drain electrode 175b form a second thin film transistor Qb along with the second semiconductor layer 154b. A channel of the second thin film transistor Qb is formed at the second semiconductor layer 154b between the second source electrode 173b and the second drain electrode 175b.

The third gate electrode 124c, the third source electrode 173c, and the third drain electrode 175c form a third thin film transistor Qc along with the third semiconductor layer 154c. A channel of the third thin film transistor Qc is formed at the third semiconductor layer 154c between the third source electrode 173c and the third drain electrode 175c.

The second drain electrode 175b is coupled to the third source electrode 173c and includes a wide expansion 177.

A first passivation layer 180p is disposed on the data conductors 171, 173c, 175a, 175b, and 175c, and on the exposed portions of the semiconductor layers 154a, 154b, and 154c. The first passivation layer 180p may be an inorganic insulating layer that is formed of a silicon nitride or a silicon oxide. The first passivation layer 180p may prevent a pigment of a color filter 230 from flowing into exposed portions of the semiconductor layers 154a, 154b, and 154c.

A vertical light blocking member 220a and the color filter 230 are disposed on the first passivation layer 180p. The vertical light blocking member 220a may have a planar shape identical or similar to that of the data line 171, and is formed to cover the data line 171.

In the present specification, the light blocking member 220a extending in the vertical direction is described, but it is not limited thereto. For example, a shielding electrode simultaneously formed with the pixel electrode, and to which the common voltage is applied, may be applied instead of the light blocking member 220a.

The color filter 230 extends in the vertical direction along two adjacent data lines. Two adjacent color filters 230 may be spaced apart from each other by the data lines 171, or may overlap each other near the data lines 171. The color filter 230 may uniquely display a primary color, such as one of the three primary colors red, green, and blue, or one of the three primary colors yellow, cyan, magenta, and the like.

In some cases, the color filter 230 may display a non-primary color (e.g., a mixture of the primary colors such as white).

A second passivation layer 180q is disposed on the color filter 230 and the vertical light blocking member 220a. The second passivation layer 180q may be an inorganic insulating layer that is formed of a silicon nitride or a silicon oxide.

The second passivation layer 180q prevents the color filter 230 from being lifted and suppresses contamination of the liquid crystal layer 3 from an organic material, such as a solvent introduced from the color filter 230, thereby preventing an abnormality such as a residual image that may otherwise occur when a screen is driven.

A first contact hole 185a and a second contact hole 185b are disposed in the first passivation layer 180p, the color filter 230, and the second passivation layer 180q to expose the first and second drain electrodes 175a and 175b, respectively. A third contact hole 185c is disposed in the first passivation layer 180p, the second passivation layer 180q, and the gate insulating layer 140 to partially expose the reference electrode 137 and the third drain electrode 175c.

A connecting member 195 covers the third contact hole 185c. The connecting member 195 electrically couples the reference electrode 137 and the third drain electrode 175c that are exposed by the third contact hole 185c.

A plurality of pixel electrodes 191 is disposed on the second passivation layer 180q. The pixel electrodes 191 are separated from each other, and include a first subpixel electrode 191a and a second subpixel electrode 191b neighboring each other in a column direction with a gate line 121 disposed in between. The pixel electrode 191 may be formed of a transparent conductive material such as ITO, IZO, or the like, or a reflective metal such as aluminum, silver, chromium, or an alloy thereof. The first and second subpixel electrodes 191a and 191b may include one or more of the electrodes illustrated in FIG. 4, or variations thereof.

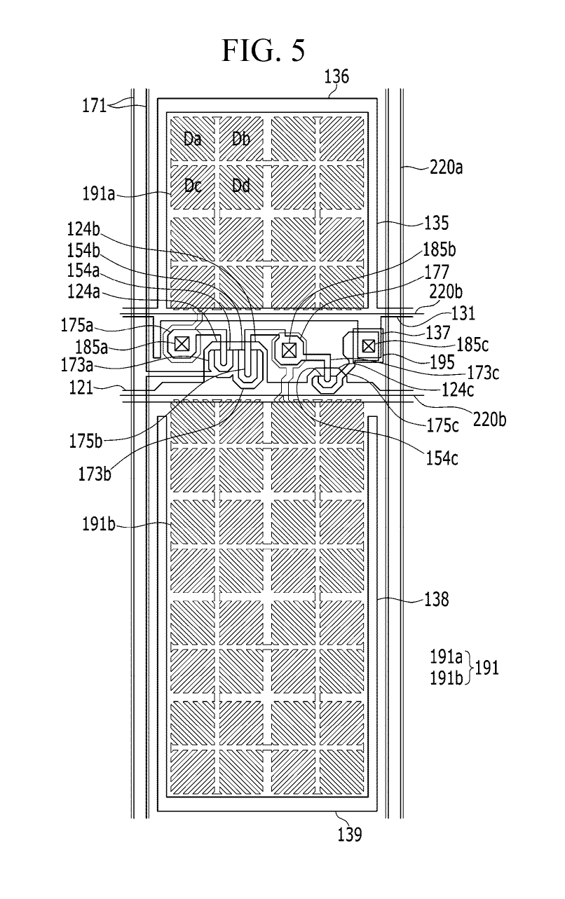

An exemplary embodiment including one or more electrodes is described below with reference to FIG. 5.

The first and second subpixel electrodes 191a and 191b are physically and electrically coupled to the first and second drain electrodes 175a and 175b through the first and second contact holes 185a and 185b, and are applied with the data voltage from the first and second drain electrodes 175a and 175b, respectively.

The data voltage applied to the second drain electrode 175b may be partially divided by the third source electrode 173c such that the voltage applied to the first subpixel electrode 191a is greater than that applied to the second subpixel electrode 191b. When the data voltage is applied, the first and second subpixel electrodes 191a and 191b generate an electric field with a common electrode 270 of the upper panel 200. The generated electric field determines the alignment directions of the liquid crystal molecules in the liquid crystal layer 3 between the two electrodes 191 and 270. The luminance of the light passing through liquid crystal layer 3 varies depending on the determined alignment directions of the liquid crystal molecules.

A shielding electrode (not shown) may be applied when the vertical light blocking member 220a is omitted, and may be disposed in the same layer where the pixel electrode 191 is disposed. The shielding electrode and the pixel electrode 191 may be simultaneously formed using the same mask. That is, the shielding electrode may be formed of the same material as or a different material from the pixel electrode 191.

The shielding electrode (not shown) may be disposed to overlap the data line 171, and may have a planar shape that is identical or similar to the shape of the data line 171. The shielding electrode may be formed as a continuum across all the adjacent pixels. The shielding electrode may be formed of a transparent conductive material such as ITO (indium tin oxide), IZO (indium zinc oxide), or the like, or a reflective metal such as aluminum, silver, chromium, or an alloy thereof.

Since the shielding electrode is applied with the same voltage as the common electrode 270, no electric field is generated between the shielding electrode and the common electrode 270. As such, the liquid crystal molecules disposed between the shielding electrode and the common electrode 270 are not aligned by an electric field. In other words, the liquid crystals disposed between the shielding electrode and the common electrode 270 do not transmit light and thus serve as a light blocking member.

Accordingly, in a display device according to an exemplary embodiment of the present system and method, a light blocking function may be provided by either one of the shielding electrode and the vertical light blocking member 220a.

A lower alignment layer 11 is disposed on the pixel electrode 191.

The upper panel 200 is now described.

A horizontal light blocking member 220b is disposed on an insulation substrate 210. The horizontal light blocking member 220b may be referred to as a black matrix (BM) and prevents leakage of light. The horizontal light blocking member 220b may be disposed to correspond to the gate line 121. That is, the horizontal light blocking member 220b extending in a row direction may be provided.

An overcoat 250 is formed on the light blocking member 220b. The overcoat 250 may be formed of an organic insulator, and provides a flat surface. In some exemplary embodiments, the overcoat 250 may be omitted.

The common electrode 270 is formed on the overcoat 250. The common electrode 270 may be formed of a transparent conductor such as ITO, IZO, etc. An upper alignment layer 21 is formed on the common electrode 270.

The liquid crystal layer 3 includes the plurality of liquid crystal molecules 31. When no voltage is applied to the two field generating electrodes 191 and 270, the liquid crystal molecules 31 are aligned with their major axis perpendicular to the planar surfaces of the two substrates 110 and 210, and pretilted in the same direction as the lengthwise direction of the cutout patterns of the pixel electrode 191.

According to an exemplary embodiment of the present system and method, the liquid crystal layer 3 or the alignment layers 11 and 21 do not include a reactive mesogen (RM). The pixel electrode of the present system and method makes it possible to control the alignment direction of the liquid crystals even without using reactive mesogen by controlling the widths of minute slits and minute branch portions of the pixel electrode, and thereby enhancing the control of the liquid crystal molecules of the lower panel. In a manufacturing process of the display device including no reactive mesogen, a UV electric field process may be omitted.

The display device described above may be a curved display device.

A basic electrode of the pixel electrode 191 is now described with reference to FIG. 4. As shown in FIG. 4, the basic electrode has a substantially quadrangular shape, and includes a cross-shaped stem portion that is composed of a horizontal stem portion 193 and a vertical stem portion 192 perpendicular thereto.

Further, the basic electrode is divided into a first subregion Da, a second subregion Db, a third subregion Dc, and a fourth subregion Dd by the horizontal and vertical stem portions 193 and 192. The first to fourth subregions Da, Db, Dc, and Dd respectively include a plurality of first minute branch portions 194a, a plurality of second minute branch portions 194b, a plurality of third minute branch portions 194c, and a plurality of fourth minute branch portions 194d.

Minute slits 195a, 195b, 195c, and 195d are disposed between the minute branch portions 194a, 194b, 194c, and 194d in the quadrangular shape of the basic electrode. That is, the minute slits 195a, 195b, 195c, and 195d represent regions where a conductor for forming the cross-shaped stem portion and the minute branch portions is removed and intervals between the adjacent minute branch portions 194a, 194b, 194c, and 194d.

The first minute branch portions 194a obliquely extend from the horizontal stem portion 193 and the vertical stem portion 192 in an upper left direction, and the second minute branch portions 194b obliquely extend from the horizontal stem portion 193 and the vertical stem portion 192 in an upper right direction. The third minute branch portions 194c obliquely extend from the horizontal stem portion 193 and the vertical stem portion 192 in a lower left direction, and the fourth minute branch portions 194d obliquely extend from the horizontal stem portion 193 and the vertical stem portion 192 in a lower right direction.

The first to fourth minute branch portions 194a, 194b, 194c, and 194d may form an angle of substantially 45° or 135° with the gate lines or the horizontal stem portion 193. In addition, the minute branch portions 194a, 194b, 194c, and 194d of two of the neighboring subregions Da, Db, Dc, and Dd may be perpendicular to each other.

The sum of a width LB of one of the minute branch portions 194a, 194b, 194c, and 194d and a width Ls of one of the minute slits may be about 5 μm to 7 μm. When the sum Lp of the width LB of the minute branch portions 194a, 194b, 194c, and 194d and the width Ls of the minute slits 195a, 195b, 195c, and 195d is about 7 μm, the width Ls of the minute slits 195a, 195b, 195c, and 195d may be more than about 4 μm, while the width LB of the minute branch portions 194a, 194b, 194c, and 194d may be less than about 3 μm. In this manner, the control of the liquid crystal molecules in the lower panel is improved because a fringe field that is generated has a greater influence on the liquid crystal molecules.

When the sum Lp of the width LB of the minute branch portions 194a, 194b, 194c, and 194d and the width Ls of the minute slits 195a, 195b, 195c, and 195d is about 6 μm, the width Ls of the minute slits 195a, 195b, 195c, and 195d may be more than about 3.5 μm, while the width LB of the minute branch portions 194a, 194b, 194c, and 194d may be less than about 2.5 μm. In this manner, the control of the liquid crystal molecules in the lower panel is improved because the fringe field has a greater influence on the liquid crystal molecules.

When the sum Lp of the width LB of the minute branch portions 194a, 194b, 194c, and 194d and the width Ls of the minute slits 195a, 195b, 195c, and 195d is about 5 μm, the width Ls of the minute slits 195a, 195b, 195c, and 195d may be more than about 3 μm, while the width LB of the minute branch portions 194a, 194b, 194c, and 194d may be less than about 2 μm. In this manner, the control of the liquid crystal molecules in the lower panel is improved because the fringe field has a greater influence on the liquid crystal molecules.

That is, according to exemplary embodiments of the present system and method, the width Ls of the minute slits 195a, 195b, 195c, and 195d is formed to be greater than the width L_{B} of the minute branch portions 194a, 194b, 194c, and 194d, such that a ratio of the width LB of the minute branch portions 194a, 194b, 194c, and 194d to the width Ls of the minute slits 195a, 195b, 195c, and 195d may be at least about 1.3. In this manner, the control of the liquid crystal molecules in the lower panel is improved, thereby allowing the luminance and the like to be controlled.

The sides of the first to fourth minute branch portions 194a, 194b, 194c, and 194d distort the electric field to generate a horizontal component that determines the tilt directions of the liquid crystal molecules 31. The horizontal component of the electric field is nearly parallel to the sides of the first to fourth minute branch portions 194a, 194b, 194c, and 194d. As shown in FIG. 4, the liquid crystal molecules 31 are tilted in a direction parallel to the lengthwise direction of the minute branch portions 194a, 194b, 194c, and 194d. Therefore, because the minute branch portions 194a, 194b, 194c, 194d extend lengthwise in different directions, the liquid crystal molecules 31 are approximately inclined in four directions such that four domains having different alignment directions of the liquid crystal molecules 31 are formed in the liquid crystal layer 3 of each pixel. When the liquid crystal molecules are inclined in various directions, a reference viewing angle of the LCD becomes wider.

In the curved display device described above, as the width of the minute slits becomes greater than that of the minute branch portions, the fringe field generated between the pixel electrode and the common electrode is increased, thereby allowing improved control over the liquid crystal molecules. Specifically, texture generation due to misalignment of the upper and lower substrates of the curved display device can be controlled and improved luminance quality can be provided.

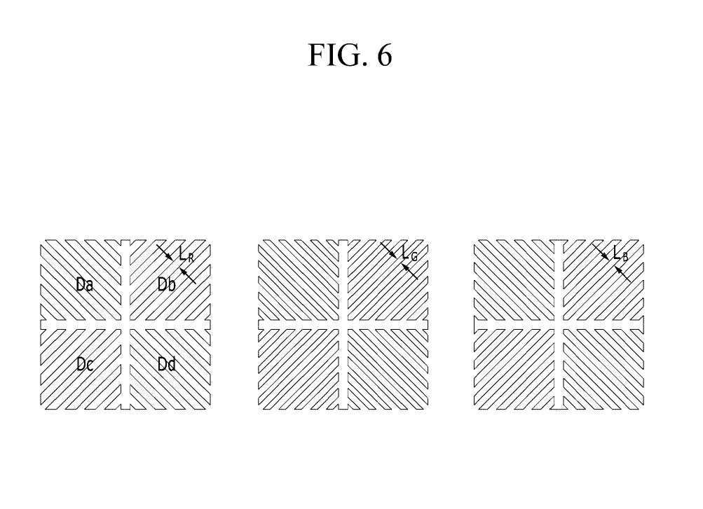

A curved display device according to another exemplary embodiment of the present system and method is now described with reference to FIGS. 5 and 6. FIG. 5 is a top plan view of one pixel area according to another exemplary embodiment of the present system and method. FIG. 6 is a top plan view of a basic electrode corresponding to each color filter according to another exemplary embodiment of the present system and method.

In the following, only the pixel electrode is described, and a description of the other constituent elements is omitted. The constituent elements omitted in the following description may be identical or similar to those described in FIGS. 2 to 4.

Referring to FIG. 5, a first subpixel electrode 191a and a second subpixel electrode 191b may respectively include a plurality of cross-shaped stem portions. As an example, the first subpixel electrode 191a may include four cross-shaped stem portions and minute branch portions extending therefrom, and the second subpixel electrode 191b may include eight cross-shaped stem portions and minute branch portions extending therefrom. However, the present system and method are not limited to the number of cross-shaped stem portions illustrated here.

As shown in FIG. 5, the plurality of cross-shaped stem portions respectively include a horizontal stem portion 193 and a vertical stem portion 192 perpendicular thereto. In addition, the subpixel electrode is subdivided into a first subregion Da, a second subregion Db, a third subregion Dc, and a fourth subregion Dd by the horizontal and vertical stem portions 193 and 192. The first to fourth subregions Da, Db, Dc, and Dd respectively include a plurality of first minute branch portions 194a, a plurality of second minute branch portions 194b, a plurality of third minute branch portions 194c, and a plurality of fourth minute branch portions 194d.

According to the exemplary embodiment of FIG. 5, each first subpixel electrode 191a includes four first subregions Da, four second subregions Db, four third subregions Dc, and four fourth subregions Dd. The second subpixel electrode 191b includes eight first subregions Da, eight second subregions Db, eight third subregions Dc, and eight fourth subregions Dd.

Minute slits 195a, 195b, 195c, and 195d are disposed between the minute branch portions 194a, 194b, 194c, and 194d in the quadrangular shape of the basic electrode. That is, the minute slits 195a, 195b, 195c, and 195d represent regions where a conductor for forming the cross-shaped stem portion and the minute branch portions is removed and intervals between the adjacent minute branch portions 194a, 194b, 194c, and 194d.

According to the exemplary embodiment illustrated in FIG. 5, the sum of a width of one of the minute branch portions 194a, 194b, 194c, and 194d and a width of one of the minute slits 195a, 195b, 195c, and 195d may be about 5 μm to 7 μm. When the sum of the width of the minute branch portions 194a, 194b, 194c, and 194d and the width of the minute slits 195a, 195b, 195c, and 195d is about 7 μm, the width of the minute slits 195a, 195b, 195c, and 195d may be more than about 4 μm, while the width of the minute branch portions 194a, 194b, 194c, and 194d may be less than about 3 μm.

When the sum of the width of the minute branch portions 194a, 194b, 194c, and 194d and the width of the minute slits 195a, 195b, 195c, and 195d is about 6 μm, the width of the minute slits 195a, 195b, 195c, and 195d may be more than about 3.5 μm, while the width of the minute branch portions 194a, 194b, 194c, and 194d may be less than about 2.5 μm.

When the sum of the width of the minute branch portions 194a, 194b, 194c, and 194d and the width of the minute slits 195a, 195b, 195c, and 195d is about 5 μm, the width of the minute slits 195a, 195b, 195c, and 195d may be more than about 3 μm, while the width of the minute branch portions 194a, 194b, 194c, and 194d may be less than about 2 μm.

That is, according to exemplary embodiments of the present system and method, the width of the minute slits 195a, 195b, 195c, and 195d are formed to be greater than that of the minute branch portions 194a, 194b, 194c, and 194d, such that a ratio of the width of the minute slits 195a, 195b, 195c, and 195d to the width of the minute branch portions 194a, 194b, 194c, and 194d may be more than about 1.3. In this manner, the control of the liquid crystal molecules in the lower panel is improved because the fringe field has a greater influence on the liquid crystal molecules.

Referring to FIG. 6, the minute branch portions 194a, 194b, 194c, and 194d and the minute slits 195a, 195b, 195c, and 195d may have correspondingly different widths depending on the color of the associated color filter, according to an embodiment of the present system and method. Specifically, if the color filter 230 is one of a red color filter (R), a green color filter (G), and a blue color filter (B), the widths of the minute branch portions 194a, 194b, 194c, and 194d and the minute slits 195a, 195b, 195c, and 195d overlapping the red color filter, the widths of the minute branch portions 194a, 194b, 194c, and 194d and the minute slits 195a, 195b, 195c, and 195d overlapping the green color filter, and the widths of the minute branch portions 194a, 194b, 194c, and 194d and the minute slits 195a, 195b, 195c, and 195d overlapping the blue color filter may respectively be different.

Although red, green, and blue color filters are described above, the present system and method are not limited to these colors. The widths of the minute branch portions 194a, 194b, 194c, and 194d and the minute slits 195a, 195b, 195c, and 195d may be different for different types of color filters.

According to an exemplary embodiment of the present system and method, the width of the minute branch portions 194a, 194b, 194c, and 194d corresponding to the red color filter, the blue color filter, and the green color filter may sequentially decrease in that order, while the width of the minute slits 195a, 195b, 195c, and 195d may increase in that order.

When the minute branch portions corresponding to the red color filter, the green color filter, and the blue color filter have the same width, the greatest decrease in luminance may occur in the pixel area corresponding to the green color filter, followed by the blue color filter, then followed by the red color filter. Accordingly, the width of the minute slits 195a, 195b, 195c, and 195d may be increased in the pixel area corresponding to the green color filter, while the width of the minute slits 195a, 195b, 195c, and 195d may be decreased in the pixel area corresponding to the red color filter where the luminance control.

This means that a width LG of the minute branch portions 194a, 194b, 194c, and 194d may be formed to be smaller in the pixel area corresponding to the green color filter, while a width LR of the minute branch portions 194a, 194b, 194c, and 194d may be formed to be relatively greater in the pixel area corresponding to the red color filter. The minute branch portions 194a, 194b, 194c, and 194d of the pixel area corresponding to the blue color filter may have a width LB between the widths L_{G} and L_{R}.

According to the exemplary embodiment of FIG. 6, differences in luminance among different-colored color filters may be controlled such that the curved display device has an overall uniform luminance.

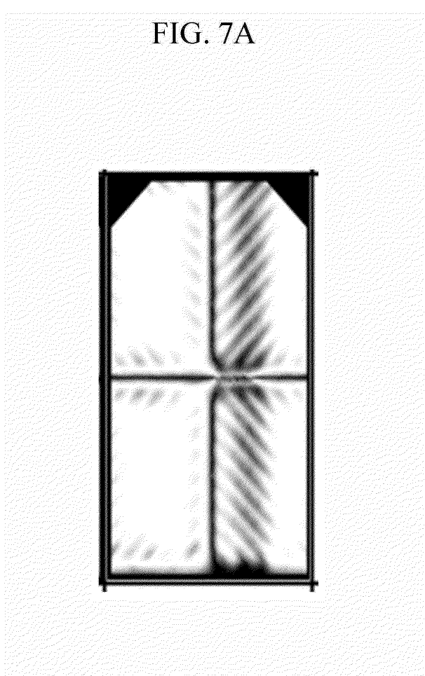

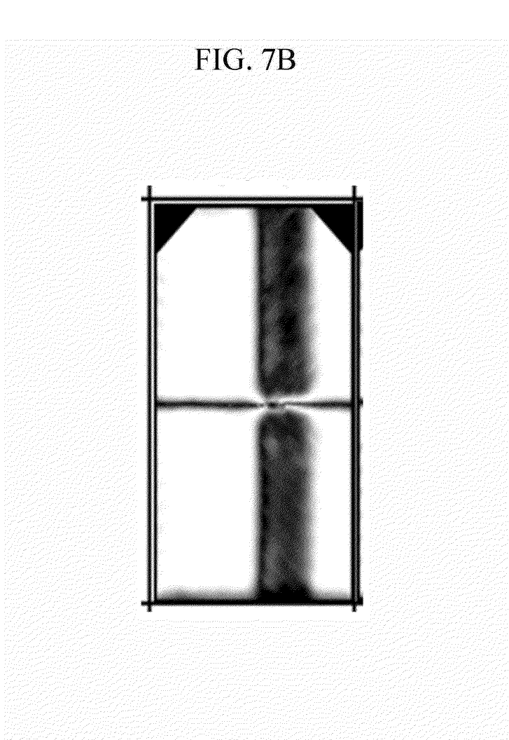

The curved display device according to the exemplary embodiments of the present system and method and comparative examples are now described with reference to FIGS. 7A to 17B.

Referring to FIGS. 7A and 7B, FIG. 7A illustrates an image of the exemplary embodiment of the present system and method in which a width of the minute branch portion is 3.0 μm and a width of the minute slit is 4.0 μm, while FIG. 7B illustrates a comparative example in which a width of the minute branch portion is 3.4 μm and a width of the minute slit is 2.6 μm.

Generally, when the display device having the pixel electrode is curved, texture and dark areas are generated. The exemplary embodiment FIG. 7A shows that texture and dark areas due to misalignment are partially generated at its right side, while the comparative example of FIG. 7B shows that texture and dark areas are significantly generated at a right side of the vertical stem portion. That is, because the widths of the minute slit and the minute branch portion are configured to improve control over the liquid crystal molecules in the embodiment of FIG. 7A, the decrease in luminance due to the misalignment is improved.

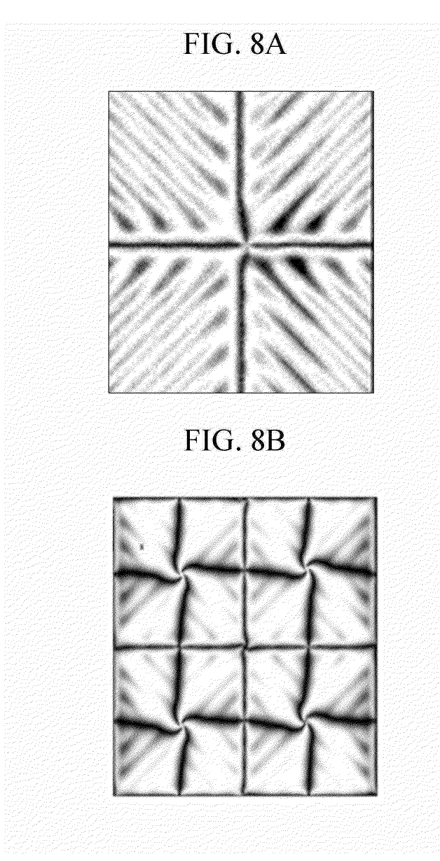

Next, referring to FIGS. 8A and 8B, FIG. 8A illustrates an image of the exemplary embodiment in which the first subpixel electrode includes one cross-shaped stem portion, while FIG. 8B illustrates an image of the exemplary embodiment in which the first subpixel electrode includes four cross-shaped stem portions.

FIG. 8A shows that dark areas are generated adjacent to the cross-shaped stem portion, while the subdivided pixel electrode of FIG. 8B shows that dark areas adjacent to the cross-shaped stem portion are controlled compared with FIG. 8A. This means that the control over the liquid crystal molecules is improved when the subpixel electrode includes a plurality of cross-shaped stem portions, and particularly, when the arrangements of the liquid crystal molecules are different in the subdivided regions.

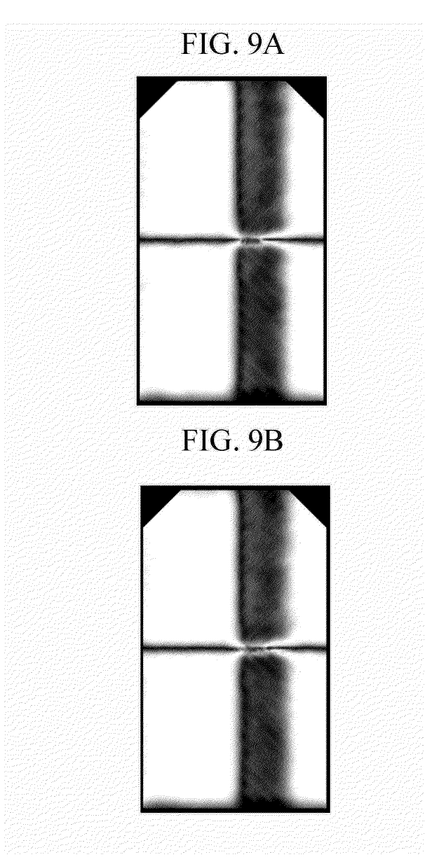

Next, FIGS. 9A and 9B illustrate images of the exemplary embodiment in which the sum of the width of the minute slit and the width of the minute branch portion is 5 μm. FIG. 9A illustrates an image of the exemplary embodiment in which the width of the minute branch portion and the width of the minute slit are each 2.5 μm. FIG. 9B illustrates an image of the exemplary embodiment in which the width of the minute branch portion is 2 μm and the width of the minute slit is 3 μm. The images show that the exemplary embodiment of FIG. 9B has improved control over the liquid crystal molecules compared with that of FIG. 9A.

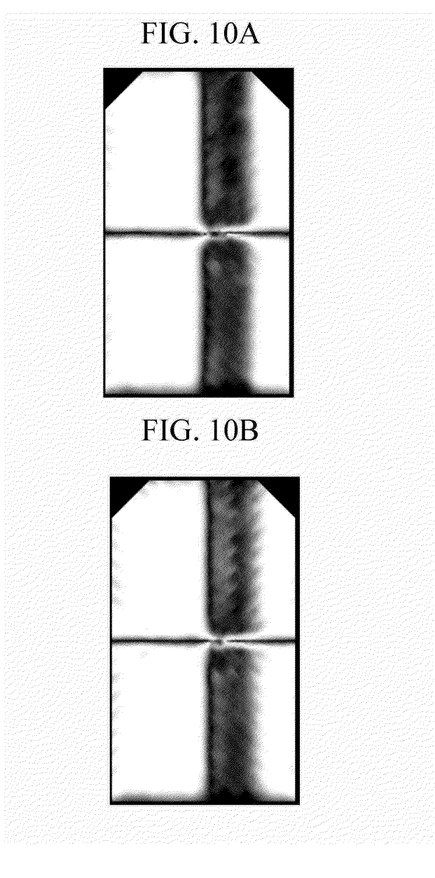

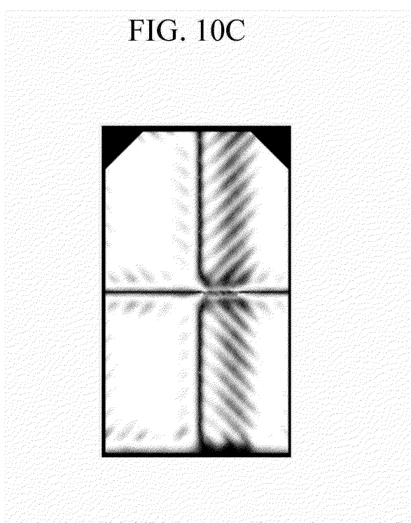

Next, FIGS. 10A, 10B, and 10C illustrate images of the exemplary embodiment in which the sum of the width of the minute branch portion and the width of the minute slit is 6 μm, FIG. 10A illustrates an image of the exemplary embodiment in which the width of the minute branch portion is 3.6 μm. FIG. 10B illustrates an image of the exemplary embodiment in which the width of the minute branch portion is 3 μm. FIG. 10C illustrates an image of the exemplary embodiment in which the width of the minute branch portion is 2 μm.

Referring to FIGS. 10A, 10B, and 10C, as the width of the minute branch portion is decreased and the width of the minute slit is increased, texture and dark areas generated at a right side of the vertical stem portion are significantly decreased. That is, as the width of the minute slit is formed to be greater than that of the minute branch portion, the control over the liquid crystal molecules improves, thereby allowing luminance to be controlled.

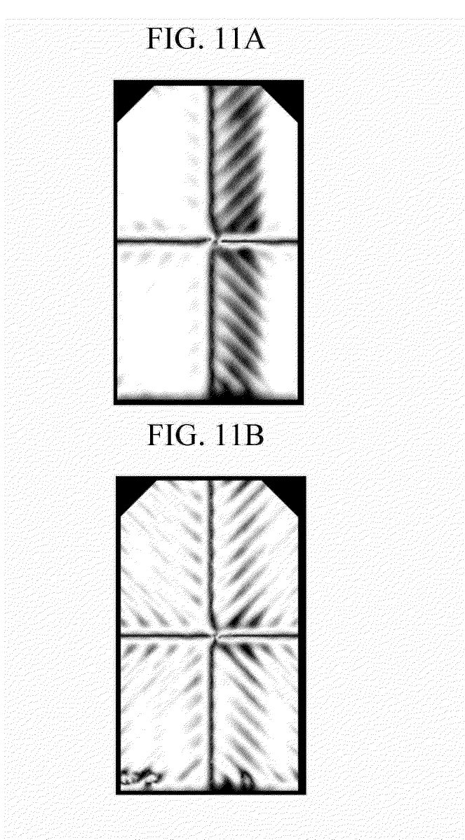

Next, FIGS. 11A and 11B illustrate images of the exemplary embodiment in which the sum of the width of the minute branch portion and the width of the minute slit is 7 μm. FIG. 11A illustrates an image of the exemplary embodiment in which the width of the minute branch portion is 3.5 μm. FIG. 11B illustrates an image of the exemplary embodiment in which the width of the minute branch portion is 2 μm.

Referring to FIGS. 11A and 11B, as the width of the minute branch portion is decreased and the width of the minute slit is increased, texture and dark areas generated at a right side of the vertical stem portion are significantly decreased. That is, as in FIGS. 11A and 11B, as the width of the minute slit is formed to be greater than that of the minute branch portion, the control over the liquid crystal molecules is improved, thereby achieving reduced texture and improved luminance.

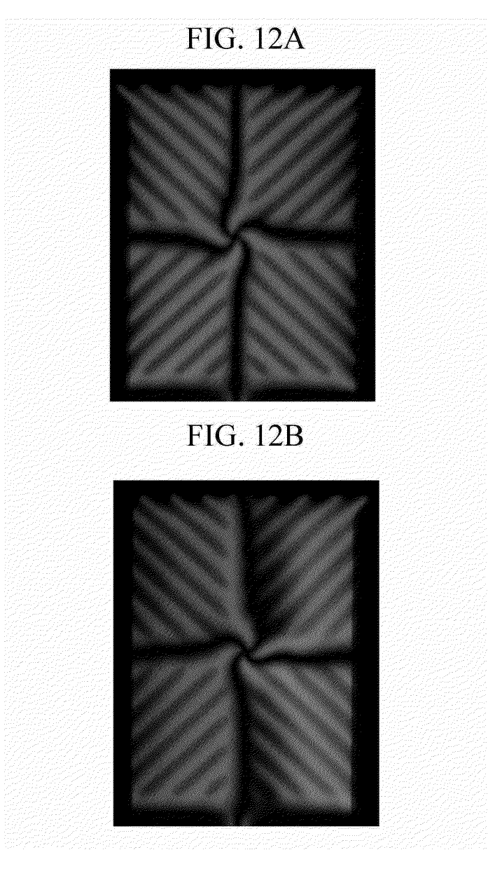

Next, FIGS. 12A to 14B illustrating images of the exemplary embodiments in which the sum of the width of the minute branch portion and the minute slit is 6 μm is now described.

FIG. 12A illustrates an exemplary embodiment of a flat display device in which the width of the minute branch portion is 3.4 μm, and FIG. 12B illustrates the exemplary embodiment of FIG. 12A as a curved display device.

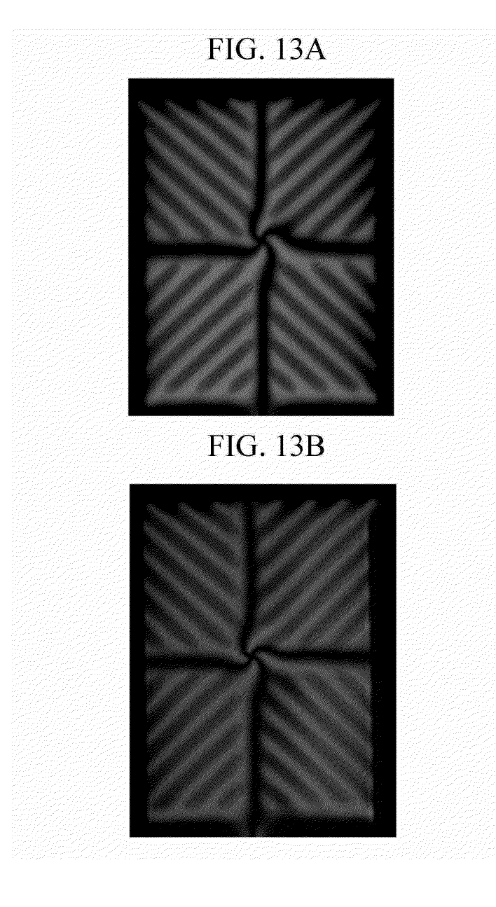

FIG. 13A illustrates an exemplary embodiment of a flat display device in which the width of the minute branch portion is 2.5 μm, and FIG. 13B illustrates the exemplary embodiment of FIG. 13A as a curved display device.

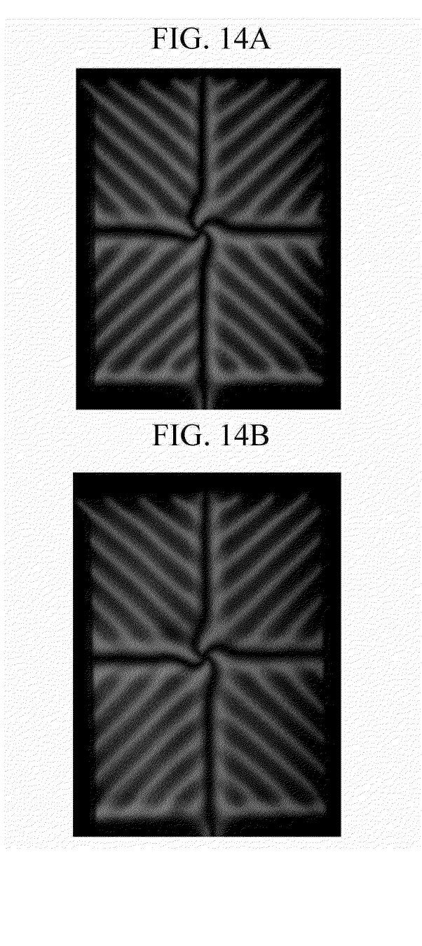

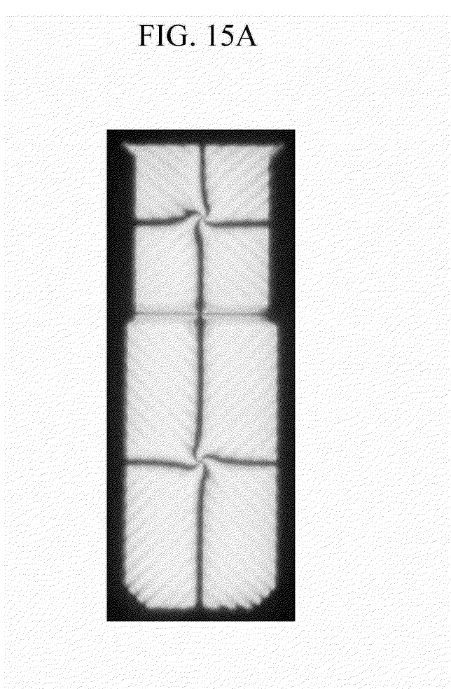

FIG. 14A illustrates an exemplary embodiment of a flat display device in which the width of the minute branch portion is 2.0 μm, and FIG. 14B illustrates the exemplary embodiment of FIG. 13A as a curved display device.

FIGS. 12A and 12B show that, in the image of the curved display device compared with that of the flat panel display, dark areas are significantly generated at a right side of the vertical stem portion and the cause a decrease in luminance by about 11.22%.

FIGS. 13A and 13B show that the curved display device is darker than the flat display and has about 7.88% lower luminance.

FIGS. 14A and 14B also show that the curved display device is darker than the flat display and has about 7.54% lower luminance.

In addition, FIGS. 12A to 14B show that in terms of a response speed variation, a speed variation of about 0.63 to 0.73 is observed. Thus, changes in the widths of the minute slits and the minute branch portions do not significantly affect the response speed.

That is, according to the comparative examples and the exemplary embodiments of FIGS. 12A to 14B, a decrease in luminance of about 70% is observed compared with that of the comparative example by changing the widths of the minute slits and the minute branch portions. This shows that the liquid crystal control is achieved by changing the widths of the minute slits and the minute branch portions.

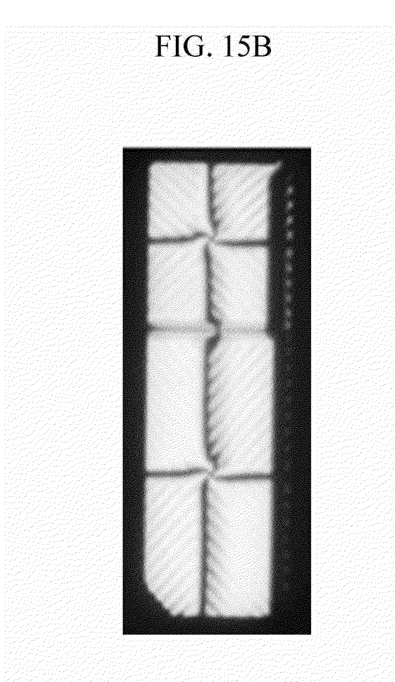

A rate of luminance reduction is described with reference to FIGS. 15A to 17B.

FIG. 15A illustrates an image of a comparative example in which the sum of the width of the minute branch portion and the width of the minute slit is 6 μm and the width of the minute branch portion is 3.4 μm. FIG. 15B illustrates an image of the flat display device of FIG. 15A when it is curved. The comparative example of FIGS. 15A and 15B shows that a rate of luminance decrease is about 12.8% when the flat display device is curved.

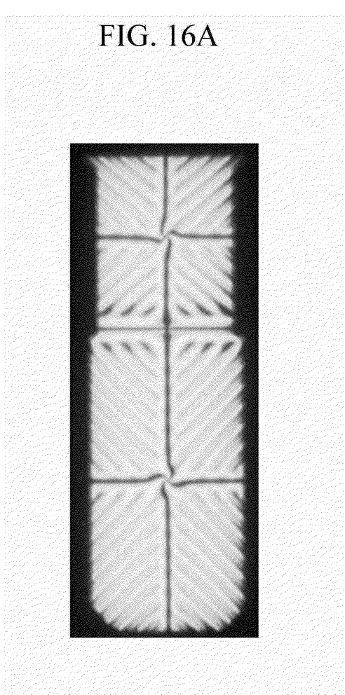

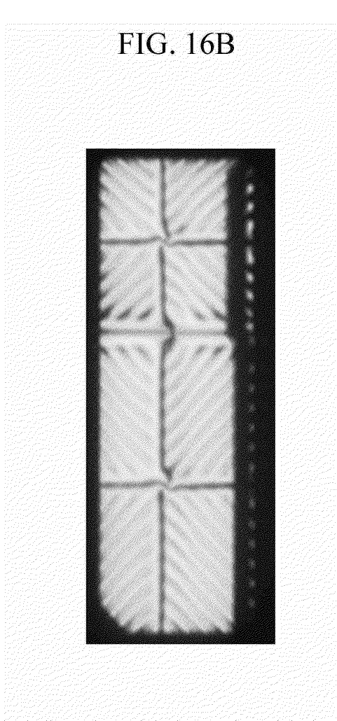

FIG. 16A illustrates an image of an exemplary embodiment of the present system and method in which the sum of the width of the minute branch portion and the width of the minute slit is 7 μm and the width of the minute branch portion is 3 μm. FIG. 16B illustrates an image of the flat display device of FIG. 16A when it is curved. In this case, compared with FIG. 16A, FIG. 16B shows that a rate of luminance decrease is about 3.6%. That is, the rate of luminance decrease only corresponds to about 30% of that of the comparative example.

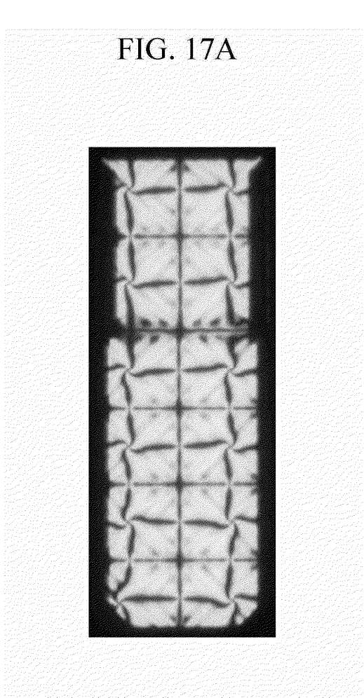

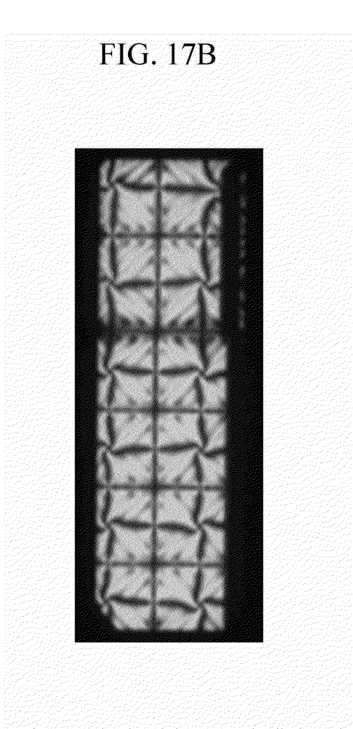

FIG. 17A illustrates an image of an exemplary embodiment of the present system and method in which the first subpixel electrode includes four cross-shaped stem portions, and the second subpixel electrode includes eight cross-shaped stem portions. FIG. 17B illustrates an image of the flat display device of FIG. 17A when it is curved. Compared with FIG. 17A, FIG. 17B shows that a decrease in luminance of only about 4.6%. This represents a decrease in luminance of about 32%, which is a significantly decreased level compared with the comparative example.

In summary, according to exemplary embodiments of the present system and method, by controlling the widths of the minute branch portions and the minute slits and/or the number of cross-shaped stem portions in the subpixel electrodes, the decrease in luminance that occurs in the curved display device can be controlled to a considerable degree. Such an effect can be caused by the enhanced liquid crystal control of the lower panel.

### DESCRIPTION OF SYMBOLS

100: lower panel 200: upper panel

110, 210: substrate 191: pixel electrode

3: liquid crystal layer 31: liquid crystal molecule

11: lower alignment layer 21: upper alignment layer

What is claimed is:

1. A curved display device comprising:
a first insulation substrate;
a gate line and a data line disposed on the first insulation substrate to cross each other;
a thin film transistor coupled to the gate line and the data line;
a pixel electrode disposed on the thin film transistor;
a common electrode facing the pixel electrode; and
a liquid crystal layer disposed between the pixel electrode and the common electrode and having liquid crystal molecules, wherein the pixel electrode includes: a cross-shaped stem portion; minute branch portions extending from the cross-shaped stem portion; and minute slits disposed between the minute branch portions, wherein a width of the minute slit is wider than that of the minute branch portion.

2. The curved display device of claim 1, wherein a ratio of the width of the minute slit to a width of the minute branch portion is more than about 1.3.

3. The curved display device of claim 1, wherein a sum of the width of the minute branch portion and the width of the minute slit is about 5 μm to 7 μm.

4. The curved display device of claim 3, wherein the sum of the width of the minute branch portion and the width of the minute slit is about 7 μm.

5. The curved display device of claim 4, wherein the width of the minute slit is more than about 4 μm.

6. The curved display device of claim 3, wherein the sum of the width of the minute branch portion and the width of one minute slit is about 6 μm.

7. The curved display device of claim 6, wherein the width of the minute slit is more than about 3.5 μm.

8. The curved display device of claim 3, wherein the sum of the width of the minute branch portion and the width of the minute slit is about 5 μm.

9. The curved display device of claim 8, wherein the width of the minute slit is more than about 3 μm.

10. The curved display device of claim 1, wherein the pixel electrode includes a first subpixel electrode and a second subpixel electrode, and the first and second subpixel electrodes are spaced apart from each other based on the gate line.

11. The curved display device of claim 10, wherein the first and second subpixel electrodes each include a plurality of cross-shaped stem portions.

12. The curved display device of claim 1, further comprising:
a gate insulating layer disposed on the gate line;
a semiconductor layer disposed on the gate insulating layer;
a first passivation layer disposed on the data line;
a color filter disposed on the first passivation layer; and
a second passivation layer disposed on the color filter and the first passivation layer.

13. The curved display device of claim 12, wherein the color filter is one of a red color filter (R), a green color filter (G), and a blue color filter (B), and widths of the minute branch portions are different depending on the color of the color filter.

14. The curved display device of claim 13, wherein the widths of the minute branch portions corresponding to the red filter, the blue color filter, and the green color filter are sequentially decreased in order.

15. The curved display device of claim 1, wherein the curved display device excludes a reactive mesogen (RM).
